(19) United States
(12) Patent Application Publication
(10) Pub. No.: US 2011/0107092 A1
(43) Pub. Date: May 5, 2011

(54) PERFORMANCE BASED AUTHENTICATION METHOD AND APPARATUS FOR SECURE COMMUNICATION

(75) Inventor: Scott A. Krig, Santa Clara, CA (US)

(73) Assignee: Advanced Micro Devices, Inc., Sunnyvale, CA (US)

(21) Appl. No.: 12/610,629

(22) Filed: Nov. 2, 2009

(51) Int. Cl. H04L 9/32

(52) U.S. Cl. 713/168

(57) ABSTRACT

An apparatus includes a first module and a second module. The first module provides a challenge. The second module performs a signature function in response to the challenge. The first module authenticates the second module based on a time required by the second module to complete the signature function and/or an amount of power consumed by the second module to complete the signature function.

### FIELD

The present disclosure generally relates to secure communications, and more particularly, to an authentication method and apparatus for secure communications.

### BACKGROUND

Secure communications between communication endpoints has become more important in modern systems that rely on such communication. For example, many digital rights management (DRM) protocols require that an endpoint such as a graphics or audio processor be authenticated before a media player application can transfer secure information, such as media information, to the endpoint device.

One known way to authenticate an endpoint is to provide a challenge to the endpoint. The challenge can include a set of data or a function. In response to the challenge, the endpoint performs a local function using the received data or performs the received function using local data. Thereafter, the endpoint sends back a signature based on the function and data. The endpoint is authenticated when the signature is correct. Once the endpoint has been authenticated, secure information can be transferred to the authenticated endpoint. While this method provides some level of trust that the endpoint is authentic, there are known methods that can be used to mimic and/or simulate the endpoint. As such, there is still a possibility that the endpoint may not actually be authentic even though it provides the correct signature.

Accordingly, a need exists for a method and apparatus to authentication an endpoint that is less susceptible to a mimicked and/or simulated endpoint in order to improve the secure communications between endpoints.

### BRIEF DESCRIPTION OF THE DRAWINGS

The invention will be more readily understood in view of the following description when accompanied by the below figures, wherein like reference numerals represent like elements:

FIG. 1 is an exemplary functional block diagram of an apparatus having a performance based authentication module;

FIG. 2 is an exemplary functional block diagram of one embodiment of the apparatus;

FIG. 3 is a flowchart depicting exemplary operations that can be performed by the apparatus; and

FIG. 4 is a flowchart depicting exemplary operations that can be performed by the performance based authentication module.

### DETAILED DESCRIPTION

In one example, an apparatus includes a first module and a second module. The first module provides a challenge. The second module performs a signature function in response to the challenge. The first module authenticates the second module based on a time required by the second module to complete the signature function and/or an amount of power consumed by the second module to complete the signature function. A related method is also disclosed.

The apparatus and method provide, among other advantages, performance based authentication of an endpoint that is more difficult to mimic and/or simulate than known apparatus and methods. As such, the apparatus and method provides an extra level of security to increase the protection of content included in secure communications. Other advantages will be recognized by those of ordinary skill in the art.

In one example, the first module provides secure information to the second module after the second module has been authenticated. In one example, the second module provides processed media information in response to the secure information. Exemplary secure information can include, inter alia, documents, records, databases, graphics, audio and/or video media, and/or other suitable secure information. In one example, the apparatus includes an visual/audio module. The visual/audio module provides an audio and/or visual representation of the secure information in response to the processed media information.

In one example, the second module provides a signature based on the signature function. The first module authenticates the second module based on the signature. In one example, the first module comprises a media application module and the second module comprise a graphics processor.

In one example, the first module includes a challenge module and an authentication module. The challenge module provides the challenge. The authentication module authenticates the endpoint module (e.g., the second module) based on the time required for the endpoint module to perform the signature function in response to the at least one challenge and/or the amount of power consumed by the second module to complete the signature function in response to the at least one challenge.

In one example, the first module includes a secure information transfer module. The secure information transfer module provides secure information to the endpoint module after the endpoint module has been authenticated.

In one example, the authentication module includes memory and a comparison module. The memory stores a time signature value based on the challenge. The comparison module provides authentication information based on a comparison between the time required for the endpoint module to perform the signature function and the time signature value, wherein the secure information transfer module is operative to provide the secure information in response to the authentication information. In one example, the memory stores signature result information corresponding to the challenge. The comparison module provides the authentication information based on a second comparison between the signature result information and the signature from the endpoint module.

As used herein, the term “module” can include an electronic circuit, one or more processors (e.g., shared, dedicated, or group of processors such as but not limited to microprocessors, DSPs, or central processing units) and memory that execute one or more software or firmware programs, combinational logic circuits, an ASIC, and/or other suitable components that provide the described functionality. Additionally, as will be appreciated by those of ordinary skill in the art, the operation, design, and organization, of a “module” can be described in a hardware description language such as Verilog™, VHDL, or other suitable hardware description languages.

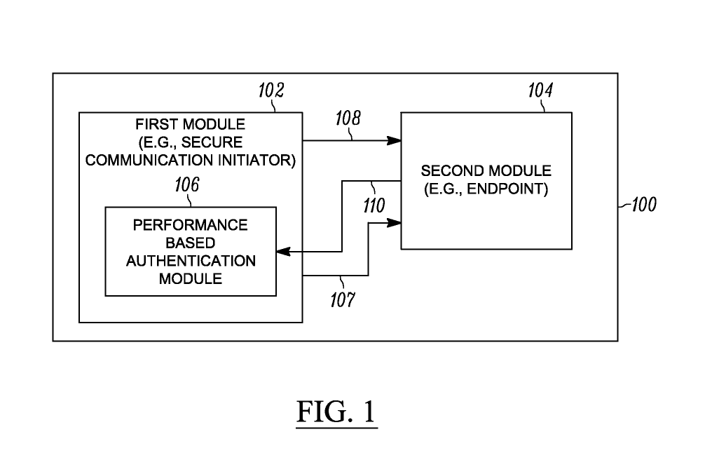

Referring now to FIG. 1, an exemplary function block diagram of an apparatus 100 such as a wireless phone, a mobile and/or stationary computer, a printer, a LAN interface (wireless and/or wired), a media player, a video decoder and/or encoder, and/or any other suitable digital device is depicted. The apparatus 100 includes a first module 102 (e.g., secure communication initiator) and a second module 104 (e.g., an endpoint). The first module 102 includes a performance based authentication module 106, which authenticates the second module 104 based its performance characteristics. After the second module 104 has been authenticated, the first module 102 provides secure information 107 to the second module 104.

During operation, the first module 102 provides a challenge 108 to the second module 104. The challenge 108 can include any type of suitable data such as one or more parameters, one or more numbers, one or more character strings, one of more symbols, one or more indexes, one or more Uniform Resource Locators (URLs), program source code, an executable program, a pathname to a file, a pathname to an executable program, and/or other suitable data. In addition, the challenge 108 can include a function if desired. Furthermore, the challenge can be unique and/or randomly generated by the first module 102.

In response to the challenge 108, the second module 104 performs a signature function and provides a response 110 based on thereon. The response 110 can include any suitable information such as a signature, an amount of power consumed by the second module 104 to perform the signature function, a time required for the second module 104 to perform the signature function, and/or other suitable information.

In one embodiment, the performance based authentication module 106 authenticates the second module 104 based on a time required for the second module 104 to perform the signature function. For example, in this embodiment, the performance based authentication module 106 can measure a time lapse between providing the challenge 108 and receiving the response 110. If the time lapse is approximately equal to an expected time lapse for the challenge 108 (or between a maximum and a minimum time lapse for the challenge 108), the performance based authentication module 106 authenticates the second module 104. Otherwise, the second module 104 is not authenticated.

In another embodiment, the performance based authentication module 106 authenticates the second module 104 based on an amount of power consumed by the second module 104 to perform the signature function. For example, in this embodiment, the performance based authentication module 106 can measure (or receive via the response 110) an amount of power consumed by the second module 104 to perform the signature function and/or provide the response 110. If the amount of power consumed is approximately equal to an expected amount of power to be consumed (or between a maximum and a minimum amount of power expected to be consumed), the performance based authentication module 106 authenticates the second module 104. Otherwise, the second module 104 is not authenticated.

In yet another embodiment, the performance based authentication module 106 authenticates the second module 104 based on both the time required for the second module 104 to perform the signature function and the amount of power consumed by the second module 104 to perform the signature function. For example, if both the time lapse is approximately equal to the expected time lapse for the challenge 108 (or between a maximum and a minimum time lapse for the challenge 108) and the amount of power consumed is approximately equal to the expected amount of power to be consumed (or between a maximum and a minimum amount of power expected to be consumed), the authentication module 106 authenticates the second module 104. Otherwise, the second module 104 is not authenticated.

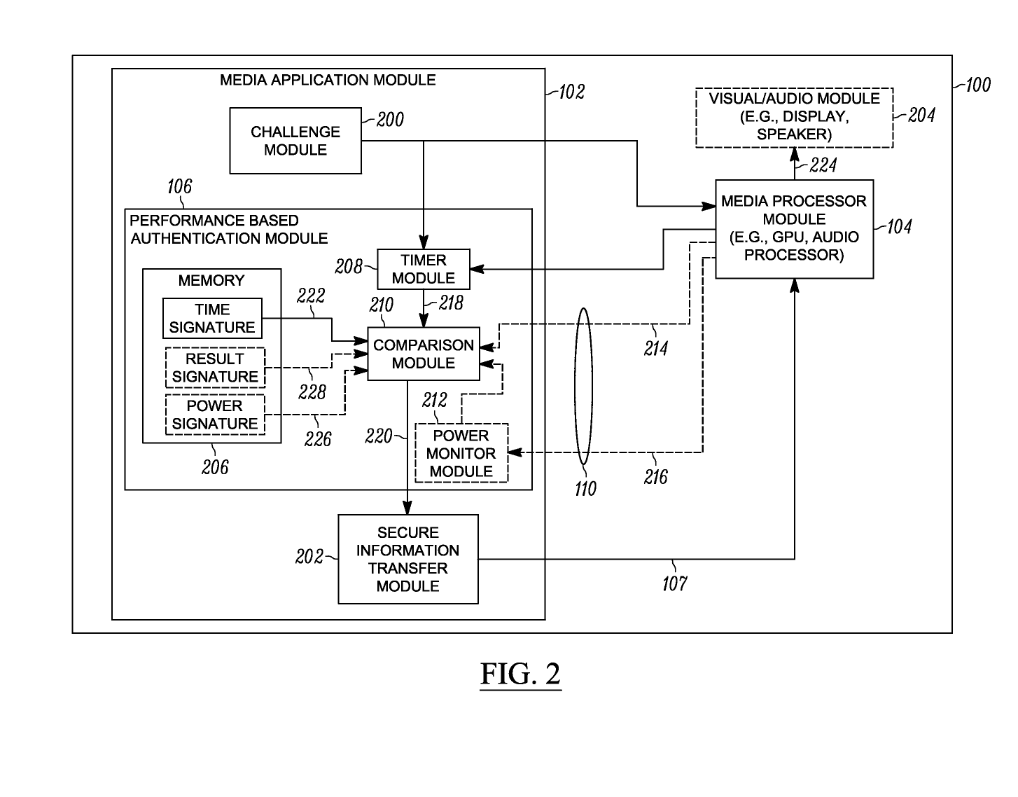

Referring now to FIG. 2, an exemplary functional block diagram of one implementation of the apparatus 100 is depicted. In this example, the first module 102 is a media application module such as iTunes™ or any other suitable media application stored in memory and executed by a processor. As such, for purposes of this example, the first module 102 is referred to as media application module 102. In addition, in this example, the second module 104 is a media processor module such as a graphics processor, an audio processor, and/or other suitable media processor. As such, for purposes of this example, the second module 104 is referred to as media processor module 104.

In this example, the media application module 102 includes a challenge module 200 and a secure information transfer module 202 in addition to the performance based authentication module 106. Furthermore, in some embodiments, the apparatus 100 can also include a visual/audio module 204 such as a display and/or speaker.

In addition, the performance based authentication module 106 includes memory 106 (e.g., volatile or non-volatile), a timer module 208, a comparison module 210, and, in some embodiments, a power monitor module 212.

During operation, the challenge module 200 provides the challenge 108 to the media processor module 104. As noted above, the challenge 108 can include any type of suitable data such as one or more parameters, one or more numbers, one or more character strings, one of more symbols, one or more indexes, one or more Uniform Resource Locators (URLs), program source code, an executable program, a pathname to a file, a pathname to an executable program, and/or other suitable data. In addition, the challenge 108 can include a function is desired. Furthermore, the challenge can be unique and/or randomly generated by the challenge module 200.

In response to the challenge 108, the second module 104 performs a signature function based thereon and provides the response 110. As noted above, the response 110 can include any suitable information such as a signature 214, an amount of power consumed 216 by the media processor module 104 to perform the signature function, and/or other suitable information.

In one embodiment, the performance based authentication module 106 authenticates the media processor module 104 based on the time required for the media processor module 104 to perform the signature function. More specifically, the timer module 208 provides a time lapse 218 between providing the challenge 108 and receiving the response 110.

The comparison module 210 provides authentication information 220 based on a comparison of the time lapse 218 and an expected time lapse 222 (e.g., a time signature) to complete the challenge 108. For example, if the time lapse 218 is approximately equal to the expected time lapse 222, the comparison module 210 provides the authentication information 220.

In response to the authentication information 220, the secure information transfer module 202 transfers the secure information 107 to the media processor module 104. In response to the secure information 107, the media processor module 104 provides processed media information 224 based thereon. In embodiments that include the visual/audio module 204, the visual/audio module 204 provides an audio and/or visual representation of the processed media information 224 in response thereto.

In another embodiment, the performance based authentication module 106 authenticates the media processor module 104 based on an amount of power consumed by the media processor module 104 to perform the signature function. More specifically, the power monitor module 216 monitors the amount of power consumed 216 by the media processor module 104 to perform the signature function and/or provide the response 110.

The comparison module 210 provides authentication information 220 based on a comparison of the amount of power consumed 216 and an expected amount of power consumption 226 (e.g., power signature) required to complete the challenge 108. For example, if the amount of power consumed 216 is approximately equal to the expected amount of power consumption 226 (or between a maximum and a minimum amount of power expected to be consumed), the comparison module 210 provides authentication information 220.

In yet another embodiment, the performance based authentication module 106 can authenticate the media processor module 104 based on both the time lapse 218 and the amount of power consumed 216 to perform the signature function. For example, if both the time lapse 218 is approximately equal to the expected time lapse 222 and the amount of power consumed 216 is approximately equal to the expected amount of power consumption 226 (or between a maximum and a minimum amount of power expected to be consumed), the comparison module 210 provides the authentication information 220.

In addition to authenticating the media processor module 104 based on time and/or power consumption, the performance based authentication module 106 can authenticate the media processor module 104 based on the signature 214. Accordingly, the comparison module 210 provides authentication information 220 based on a comparison of the signature 214 and an expected result signature 228 corresponding to the challenge 108. For example, if the signature 214 and the expected result signature 228 are the same, the comparison module 210 provides authentication information 220.

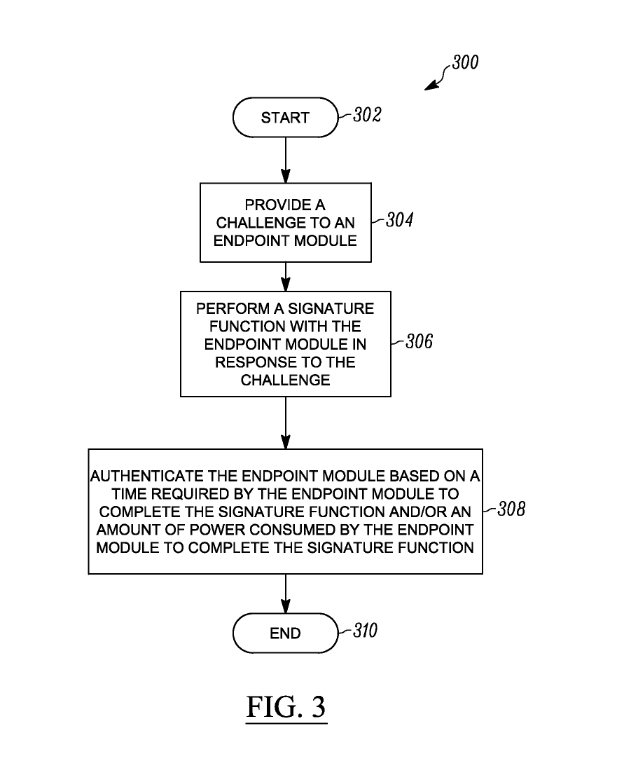

Referring now to FIG. 3, exemplary operations that can be performed by the apparatus 100 are generally identified at 300. The process starts at 302. At 304, the first module 102 provides the challenge 108 to the second module 104 (i.e., the endpoint module). At 306, the second module 104 performs the signature function in response to the challenge 108. At 308, the performance based authentication module 106 authenticates the second module 104 based on the time lapse 218 required to complete the signature function in response to the challenge 108 and/or the amount of power consumed 216 by the second module 104 to complete the signature function in response to the challenge 108. The process ends at 308.

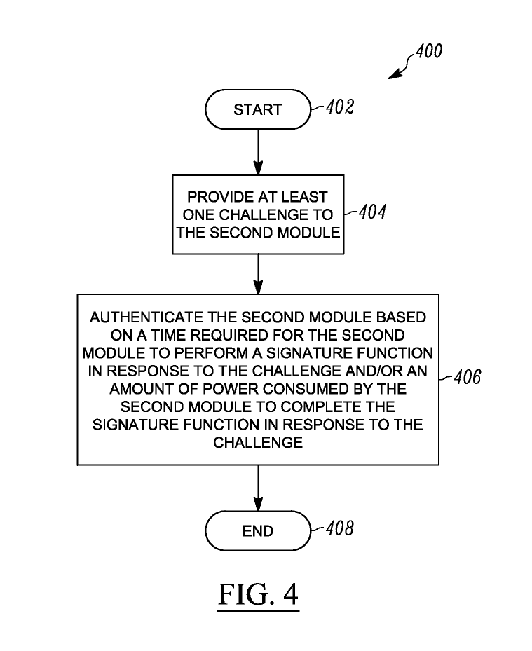

Referring now to FIG. 4, exemplary operations that can be performed by the first module 102 having the performance based authentication module 106 are generally identified at 400. The process starts at 402. At 404, the first module 102 provides the challenge 108 to the second module 104. At 406, the performance based authentication module 106 authenticates the second module based on the time lapse 218 required to complete the signature function in response to the challenge 108 and/or the amount of power consumed 216 by the second module 104 to complete the signature function in response to the challenge 108. The process ends at 408.

As noted above, among other advantages, the method and apparatus provide for performance based authentication of an endpoint that is more difficult to mimic and/or simulation than known apparatus and methods. As such, the apparatus and method provides an extra level of security to increase the protection of content included in secure communications. Other advantages will be recognized by those of ordinary skill in the art.

While this disclosure includes particular examples, it is to be understood that the disclosure is not so limited. Numerous modifications, changes, variations, substitutions, and equivalents will occur to those skilled in the art without departing from the spirit and scope of the present disclosure upon a study of the drawings, the specification, and the following claims.

What is claimed is:

1. An apparatus comprising:
a first module that is operative to provide a challenge; and
a second module that is operative to perform a signature function in response to the challenge, wherein the first module is operative to authenticate the second module based on at least one of a time required by the second module to complete the signature function and an amount of power consumed by the second module to complete the signature function.

2. The apparatus of claim 1 wherein the first module is operative to provide secure information to the second module after the second module has been authenticated.

3. The apparatus of claim 2 wherein the second module is operative to provide processed media information in response to the secure information.

4. The apparatus of claim 3 further comprising an visual/audio module that is operative to provide at least one of an audio and visual representation of the secure information in response to the processed media information.

5. The apparatus of claim 1 wherein the second module is operative to provide a signature based on the signature function and wherein the first module is operative to authenticate the second module based on the signature.

6. The apparatus of claim 1 wherein the first module comprises a media application module and the second module comprise a graphics processor.

7. A module comprising:
a challenge module that is operative to provide at least one challenge; and
an authentication module that is operative to authenticate an endpoint module based on at least one of a time required for the endpoint module to perform a signature function in response to the at least one challenge and an amount of power consumed by a second module to complete the signature function in response to the at least one challenge.

8. The module of claim 7 further comprising a secure information transfer module that is operative to provide secure information to the endpoint module after the endpoint module has been authenticated.

9. The module of claim 7 wherein the authentication module is operative to authenticate the endpoint module based on a signature provided by the endpoint module in response to the challenge.

10. The module of claim 7 wherein the authentication module comprises:
memory that is operative to store a time signature value based on the challenge; and
a comparison module that is operative to provide authentication information based on a comparison between the time required for the endpoint module to perform the signature function and the time signature value, wherein the secure information transfer module is operative to provide the secure information in response to the authentication information.

11. The module of claim 10 wherein the memory is operative to store signature result information based on the challenge and the comparison module that is operative to provide the authentication information based on a second comparison between the signature result information and the signature from the endpoint module.

12. A method of authenticating an endpoint module performed by an apparatus having secure information, comprising:
providing a challenge to the endpoint module; and
performing a signature function with the endpoint module in response to the challenge;
authenticating the endpoint module based on at least one of a time required by the endpoint module to complete the signature function and an amount of power consumed by the endpoint module to complete the signature function.

13. The method of claim 12 further comprising providing secure information to the endpoint module after the endpoint module has been authenticated.

14. The method of claim 13 further comprising:
providing processed media information in response to the secure information; and
providing at least one of an audio and visual representation of the secure information in response to the processed media information.

15. The method of claim 12 further comprising authenticating the endpoint module in response to a signature, received from the endpoint module, that is based on the signature function.

16. A method performed by a first module to authenticate a second module, comprising:
providing at least one challenge to the second module; and
authenticating the second module based on at least one of a time required for the second module to perform a signature function in response to the at one challenge and an amount of power consumed by the second module to complete the signature function in response to the at least one challenge.

17. The method of claim 16 further comprising providing secure information to the second module after the second module has been authenticated.

18. The method of claim 16 further comprising authenticating the second module based on a signature provided by the second module in response to the challenge.

19. The method claim 16 further comprising:
providing authentication information based on a comparison of a stored time signature value that is based on the challenge and the time required for the second module to perform the signature function; and
providing the secure information in response to the authentication information.

20. The method of claim 19 further comprising providing the authentication information based on a second comparison between the signature result information and the signature from the second module.
